(19) United States
(12) Patent Application Publication
(10) Pub. No.: US 2009/0248528 A1
(43) Pub. Date: Oct. 1, 2009

(54) SYSTEM AND METHOD FOR ONLINE MARKETING, SALES AND ADVERTISING

(76) Inventor: Robin Bayhack, Johannesburg (ZA)

Correspondence Address: HAHN AND MOODLEY, LLP, P.O. BOX 52050, MINNEAPOLIS, MN, 55402, US

(21) Appl. No.: 12/405,067

(22) Filed: Mar. 16, 2009

Related U.S. Application Data
(60) Provisional application No. 61/037,103, filed on Mar. 17, 2008.

(51) Int. Cl. G06Q 30/00; H04N 1/40; G06Q 10/00; G06F 15/16

(52) U.S. Cl. 705/14.52; 358/448; 709/206; 382/321; 382/181

(57) ABSTRACT

A system for providing relevant information to a recipient of a facsimile contained in an e-mail in a FTM environment, which system includes receiving a facsimile from a sender, and digitizing said facsimile, processing the facsimile by optical character recognition (OCR) or similar software, analyzing the OCR'd facsimile content for keywords, submitting the keywords as obtained from the telefaxes to search engines and/or companies for identifying content relevant to the keywords, and thus the facsimile, and inclusion of some or all of the identified relevant content in the body of the email delivering the telefax to the recipient.

This application claims priority from U. S. provisional patent application 61/037,103 of 17 Mar. 2008, the entire contents of which are incorporated herein by reference.

### FIELD OF THE INVENTION

The invention pertains to systems and methods for providing information or advertisements to an on-line and/or email user.

### BACKGROUND OF THE INVENTION

The advent of telefax to Email (FTM) in recent years has had enormous benefit to computer/internet users in that for the first time telefax transmissions could be received as an attachment in an email and not by way of a telefax machine connected to a telephone line. This includes the subscription model and CPP model—Calling Party Pays.

In terms of telefax to Email processes the telefaxed document is delivered to the recipient is by way of a PDF or TIFF (may be other) image as an attachment in an email addressed to the recipients email address.

FTM exists in most major countries either as a subscription model (majority) where the user/recipient of telefaxes would pay a monthly fee for the service, or CPP—Calling Party Pays in terms of a Telco regulated premium rated service.

The body of the email to which the attachment/telefax is attached serves no purpose other than to notify the recipient that a telefax is attached.

### GLOSSARY OF TERMS

The terms fax, telefax, and facsimile all refer to the same mode of communication and are used interchangeably in this document.

The terms fax to email, Fax2mail, fax2email, and FTM all refer to a system in which a sender sends a fax to an addressee and which fax is received by an intermediary server which receives faxes on behalf of the addressee and on which server the fax is digitized and delivered to an e-mail address of the addressee as an attachment.

The term keyword includes reference to keyword/s and/or phrase/s which capture the essence of the topic of the information.

The term DDI refer's to Direct Dialling Inward and the term DID refer's to Direct Inward Dialling.

### SUMMARY OF THE INVENTION

Digitization and Optical Character Recognition of documents has provided a means of programmatically analyzing information contained within documents.

According to the invention, there is provided a system for providing relevant information to a recipient of a facsimile contained in an e-mail in a FTM environment, which system includes:

receiving a facsimile from a sender, and digitizing said facsimile;

processing the facsimile by optical character recognition (OCR) or similar software;

analyzing the OCR'd facsimile content for keywords;

submitting the keywords as obtained from the telefaxes to search engines and/or companies for identifying content relevant to the keywords, and thus the facsimile; and

inclusion of some or all of the identified relevant content in the body of the email delivering the telefax to the recipient.

The system may thus use the keywords as obtained from the telefaxes to identify related products and/or services offered in the market place and to report same to the recipient.

In addition to using the information contained within the document, then system may use a recipient's demographical information, such as country of residence, interests, occupation, income, and the like to identify related products and/or services

Information about products and services associated with the identified relevant content may be accessed from local databases or via systems provided by external companies, which will be interrogated and analyzed to provide targeted advertising

The relevant content may include advertising relevant to the content of the telefax and/or recipient or links to internet content relevant to the telefax and/or recipient, such advertising being delivered by way of hypertext links and/or interactive banner ads and/or other methods.

The recipient may be able to peruse the products and/or services offered by clicking on hypertext links or banner ads or by other such methods.

The generating of revenue from companies may be in respect of each impression and/or click—through and/or purchase and/or enquiries generated and/or leads generated for products or services, by the fax to email recipients who respond to the adverts as contained in the body of the email.

The system may retain information about a facsimile recipient and create user profiles thereby to increase the amount of information related to the user that can be used to further analyze and target related products and/or services and to increase the relevance of the advertising and/or links delivered to the recipient.

The receiving of a facsimile from a sender may be on an FTM server or on another server which forwards it to an FTM server for forwarding to the recipient.

The OCR processing may be on the FTM server or on another server.

The creation of profiles and storage of user data may be on a dedicated secure server or on the FTM server.

The advantages and features an example of the present invention will become readily apparent from the following detailed description of the invention and the embodiments thereof, from the claims and from the accompanying drawings.

### BRIEF DESCRIPTION OF THE DRAWINGS

FIG. 1 is a graphical representation of the 9 steps of an example of the system of the invention; and

FIG. 2 is a schematic of the system of the invention.

### DETAILED DESCRIPTION

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

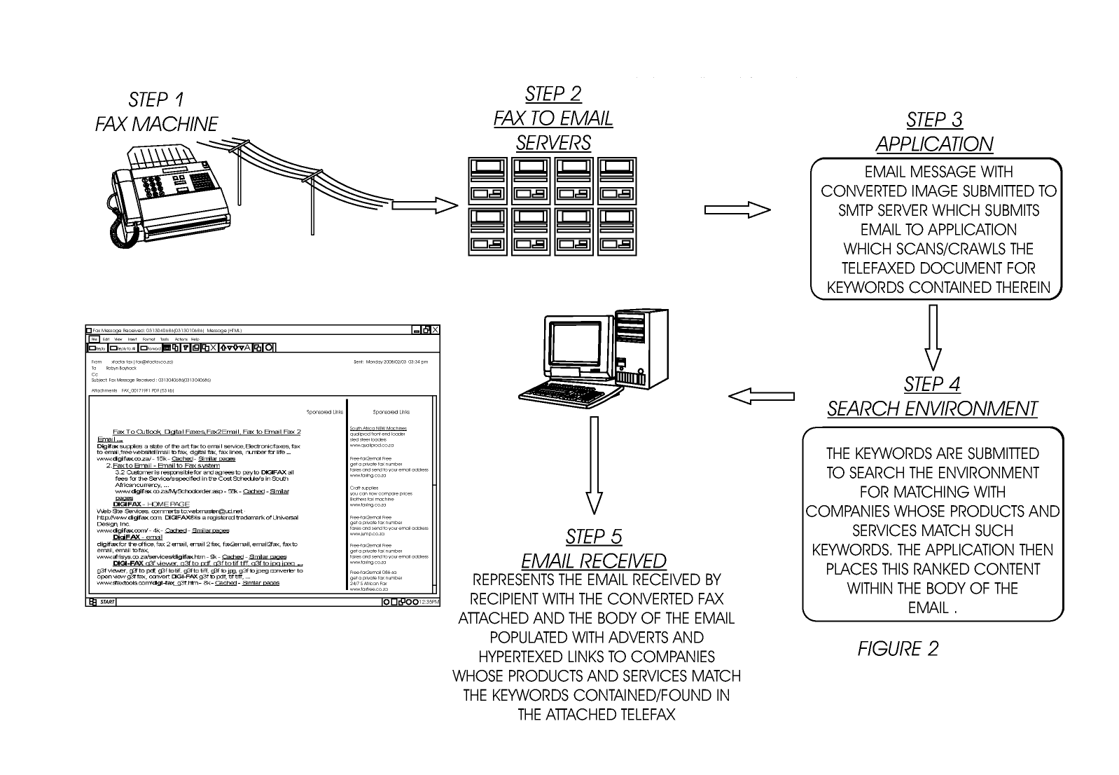

In FIG. 2 there is shown an embodiment of a system and method that embodies the invention which provides the ability for potential advertisers to utilize an unused medium of Fax to Mail, by delivering to the recipient targeted and relevant adverts.

Systems and methods that embody the invention provide the ability for recipients of Fax to Email to be offered targeted and relevant adverts via the un-used medium of fax to email.

Systems and methods that embody the invention can be utilized and applied to any FAX to Email server in order to deliver to recipients targeted and relevant adverts.

The sender of a telefax to a recipient sends the telefax.

The telefax is received by the Fax to Mail server.

The telefax is then converted into a TIFF or PDF image (or any other appropriate imaging format).

The DDI number is matched to the recipient email address allocated to the Fax2Email recipient/user. This process occurs either before or after or is part of the receiving process.

The converted fax image is attached to an email message, addressed to the aforesaid email recipient (that is associated with the DDI number).

The email message, together with the attached converted fax image, is submitted to an industry standard SMTP (Simple Mail Transfer Protocol) server, which then submits the email to an application for scanning the content of the attached fax image. Such an application can either be installed on the same server as the SMTP software, or on a standalone server.

Systems and methods that embody the invention “crawls” or “scans” the word/s or phrase/s contained in the received telefax document—the attached image. The word/s or phrase/s is/are then submitted to companies and/or matched to resources in the database that contain such words or phrases.

Once the application has placed the adverts within the body of the email, with the attached converted fax image, the results are then delivered to the recipients in an email to which is attached the actual converted telefax document containing specific and targeted adverts of products and services with hypertext links and/or interactive banner ads and/or other methods in the body of the email.

The generating of revenue from companies may be in respect of each impression and/or click—through and/or purchase and/or enquiries generated and/or Leads generated of products or services, by the fax to email recipients who respond to the adverts as contained in the body of the email.

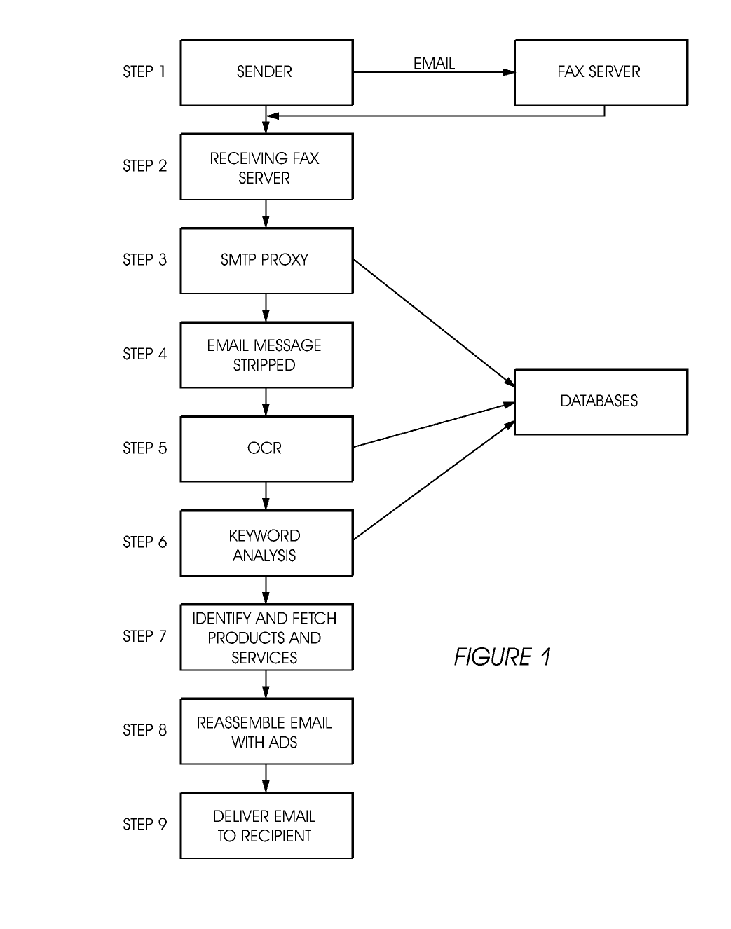

In the example as illustrated in the flow diagram of FIG. 1:

Step 1 represents a telefax transmission being telefaxed through to the recipient.

Step 2 represents the telefax reception process and conversion to required attachment type.

Step 3 represents the email message together with the attached converted image being intercepted by an industry standard SMTP server, which then submits the email with attached converted image to this patented application process.

Step 4 represents the application stripping the original email message for processing and storing relevant information to a database.

Step 5 represents the application conducting optical character recognition on the digitzed document that returns and stores the text contained within it.

Step 6 represents the keyword analyses which uses algorithms to identify the probable words or phrases that captures the essence of the topic of the information and are stored in a database.

Step 7 represents the process of identifying and/or fetching related products and services from a database or systems offered by other companies.

Step 8 represents the reassembly of the original email message with the attached facsimile document as well as the insertion of related product and services in the body of the message for the perusal by the intended recipient.

Step 9 represents the delivery of the email message to the recipient via standard SMTP.

1. A system for providing relevant information to a recipient of a facsimile contained in an e-mail in a FTM environment, which system includes:
receiving a facsimile from a sender, and digitizing said facsimile;
processing the facsimile by optical character recognition (OCR) or similar software;
analyzing the OCR'd facsimile content for keywords;
submitting the keywords as obtained from the telefaxes to search engines and/or companies for identifying content relevant to the keywords, and thus the facsimile; and
inclusion of some or all of the identified relevant content in the body of the email delivering the telefax to the recipient.

2. A system as claimed in claim 1, which uses the keywords as obtained from the telefaxes to identify one or more related products and services offered in the market place and to report same to the recipient.

3. A system as claimed in claim 1, also using demographical information to identify related products and/or services

4. A system as claimed in claim 1, wherein information about products and services associated with the identified relevant content is accessed from local databases or via systems provided by external companies, which are interrogated and analyzed to provide targeted advertising

5. A system as claimed in claim 1, wherein the relevant content includes advertising relevant to the content of one or more of the telefax and the recipient.

6. A system as claimed in claim 1, wherein the relevant content includes links to internet content relevant to one or more of the telefax and the recipient.

7. A system as claimed in claim 6, wherein the advertising is delivered by way of one or more of hypertext links, interactive banner ads, and other such methods.

8. A system as claimed in claim 1, wherein the recipient is able to peruse one or more of the products and the services offered by clicking on one or more of hypertext links, banner ads, and other similar device.

9. A system as claimed in claim 1, wherein generating of revenue from companies is in respect of one or more of each impression, click-through, purchase, enquiries generated, and leads generated for products or services, by the fax to email recipients who respond to the adverts as contained in the body of the email.

10. A system as claimed in claim 1, wherein the facsimile from a sender is received on an FTM server or on another server which forwards it to an FTM server for forwarding to the recipient.

11. A system as claimed in claim 1, wherein the OCR processing is on the FTM server or on another server.

12. A system as claimed in claim 1, wherein user profiles are created and user data is stored on a dedicated secure server or on the FTM server.

13. A method of providing relevant information to a recipient of a facsimile contained in an e-mail in a FTM environment, which method includes:
digitizing the contents of a received facsimile;
processing the facsimile by optical character recognition (OCR) or similar software;
analyzing the OCR'd facsimile content for keywords;
submitting the keywords as obtained from the telefaxes to search engines and/or companies for identifying content relevant to the keywords, and thus the facsimile; and
inclusion of some or all of the identified relevant content in the body of the email delivering the telefax to the recipient.
